(19) United States
(12) Patent Application Publication
(10) Pub. No.: US 2008/0001848 A1
(43) Pub. Date: Jan. 3, 2008

(54) METHOD OF PUBLIC SERVICE AND ADVERTISING

(76) Inventor: James H. Johnson, Jr., Lexington, KY (US)

Correspondence Address: KING & SCHICKLI, PLLC, 247 NORTH BROADWAY, LEXINGTON, KY, 40507, US

(21) Appl. No.: 11/852,593

(22) Filed: Sep. 10, 2007

Related U.S. Application Data
(63) Continuation of application No. 11/492,269, filed on Jul. 25, 2006.
(60) Provisional application No. 60/702,476, filed on Jul. 26, 2005.
(60) Provisional application No. 60/727,136, filed on Oct. 14, 2005.
(60) Provisional application No. 60/782,950, filed on Mar. 16, 2006.

(51) Int. Cl. G09G 5/00

(52) U.S. Cl. 345/1.2

(57) ABSTRACT

A method of public service includes placing electronic display devices on storage structures positioned at various product retailers, displaying advertising on the devices, storing emergency relief supplies such as water and food in those storage structures and issuing public service messages such as “Amber Alert” messages on the devices.

This application is a continuation of U.S. patent application Ser. No. 11/492,269 filed on 25 Jul. 2006 which claims the benefit of U.S. provisional patent applications Ser. No. 60/702,476 filed 26 Jul. 2005, No. 60/727,136 filed 14 Oct. 2005 and No. 60/782,950 filed 16 Mar. 2006.

### TECHNICAL FIELD

The present invention relates to the fields of public service and business promotion.

### BACKGROUND OF THE INVENTION

An “Amber Alert” is a public service message that advises the public about a missing or kidnaped child. Such alerts typically include information about the child including a description and photograph and when known available information about the kidnapper including a description and photograph. If a vehicle is involved, a description of the vehicle and a license plate number may be provided.

The “Amber Alert” is typically issued over radio, broadcast television and cable television pathways in order to reach as much of the public as possible. To date, the Amber Alert program has been very successful. The present invention allows an Amber Alert or other public service message to reach the public at various retail locations, thereby increasing the effectiveness of the alert.

### SUMMARY OF THE INVENTION

In accordance with the present invention, a method of public service is provided. That method comprises the steps of placing electronic display devices or storage structures positioned at various product retailers, displaying advertising over the electronic display devices, storing emergency relief supplies in those storage structures and issuing an “Amber Alert” emergency message over the electronic display devices. The method may further include placing the storage structures at convenience stores or other stores along an interstate highway.

The following is a detailed description of the invention. It should be realized, however, that this is just one possible embodiment of the invention and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention and together with the description serves to explain certain principles of the invention. In the drawing:

FIG. 1 is a perspective view of the integrated advertising and building structure of the present invention; and

FIG. 2 is a schematical end elevational view of the structure of FIG. 1 through the open end doors.

### DETAILED DESCRIPTION OF THE INVENTION

In accordance with the present invention, a method of public service is provided. That method may be broadly defined as including the steps of placing electronic display devices at various product retailers, displaying advertising over the electronic display devices and issuing an “Amber Alert” emergency or other public service message over the electronic display devices. The method may further include placing the electronic display devices at gas stations, convenience stores or any stores or other locations along an interstate highway. Further, the electronic display devices may be placed for viewing outdoors.

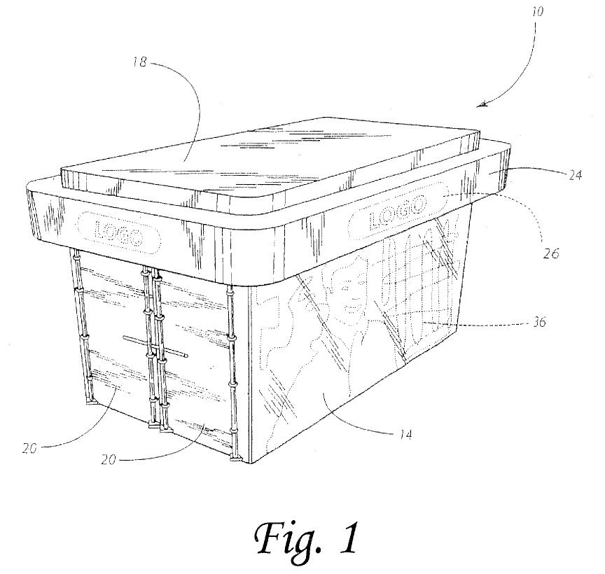

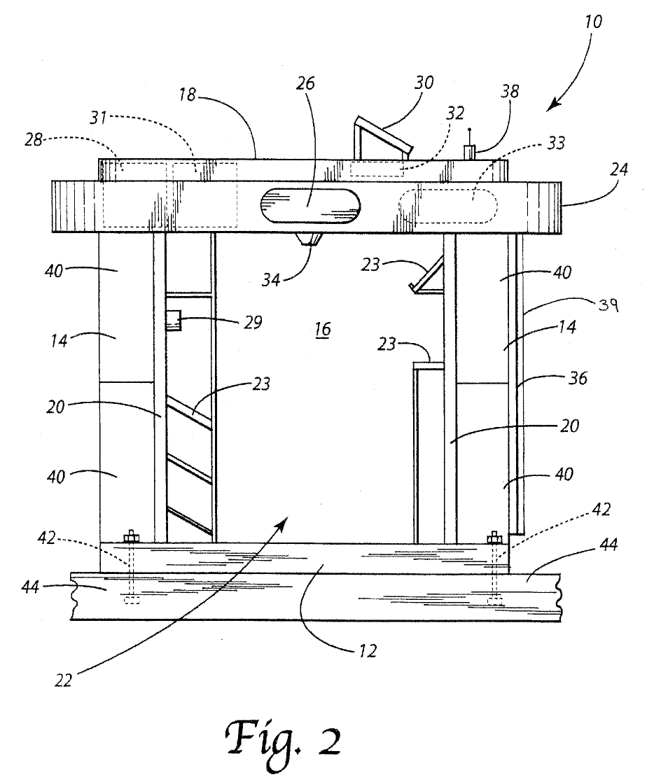

For purposes of this document, the terminology “electronic display device” means an electronic message board or video monitor such as an LCD, LED display, plasma monitor or the like. Essentially any device capable of providing a selected message or image from a remote location may be utilized. In one possible embodiment illustrated in FIGS. 1 and 2, the display device is provided on a storage structure 10. Significantly, the message or image may be programmed for viewing on any or all the electronic display devices in the network in “real time.” As such, the invention provides a very flexible and effective public service and advertising medium.

More specifically, the structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior space 22. That space 22 may be customized to meet any special needs for storing or staging such things as product inventory, trash receptacles, equipment or even emergency relief supplies such as water, food, first aid kits, medicine, ice, blankets, tents, bedding and the like.

Similarly, the exterior of the structure 10 may be customized to match the trade dress of substantially any desired party and/or architectural features of any building near which the structure 10 may be placed into service. Thus, for example, the structure 10 may include a decorative roof cap 24 sized and shaped to a user's specifications. The roof cap 24 may include advertising, trade dress or logo 26 if desired and/or as allowed by local regulations.

The structure 10 may also be equipped with various electrical and/or mechanical systems. For example, a refrigeration or other temperature control unit 28 (eg. air conditioning, freezer unit, heating unit) may be provided on the structure 10 in order to provide climate control of a portion or all of the space 22 within the storage structure. For example, when emptied of supplies the structure 10 may function as a heated shelter.

In addition, the structure 10 may be equipped with an electronic display device 36 such as a message board or video display device including but not limited to a plasma monitor, liquid crystal display or LED display. Such a device 36 may be mounted on the side wall 14, end wall 16 or other exterior component of the structure 10. The device 36 may be connected into a network of electronic display devices 36 provided on other structures 10 at various locations by hard wiring, satellite, wireless internet connection or other means. Consequently it is possible to control the programming for the electronic display devices 36 in the network from a remote location. In this way the device 36 may normally be used to display product advertising and appropriate public service messages. However, in the event of an emergency such as a missing or kidnaped child, the devices in the network may be programmed to display an Amber Alert message including photographs of the missing child and/or the suspected kidnapper. Further, in the event of an actual disaster, the electronic display devices in the system may be programmed to display any appropriate emergency message including messages to direct the population to a central emergency center where additional relief supplies will be available for distribution to the general population.

Still further, the structure 10 may incorporate a radio transmitter 38 for the transmission of a short range broadcast. The various electrical components of the structure 10 may derive their power from tapping into the lines of the local electrical utility company through an electrical box 29. Further the structures may include emergency power sources for powering the electronic display devices 36 and/or radio transmitter 38 in the event of an emergency. Such emergency power sources may comprise a solar panel 30 and cooperating battery 32 to store energy for use in the event of an emergency or even an electric generator 31 that may be hand powered or powered by an internal combustion engine, propane (note propane storage tank 33), natural gas, a fuel cell or the like.

The structure 10 may be constructed, for example, from modular building materials such as prefabricated panels 40 of the type shown and described in, for example, U.S. Pat. No. 6,279,287 to Meadows, No. 5,373,678 to Hesser and No. 6,119,427 to Wyman et al. Such modular panels 40 typically incorporate a core of thermal insulating material sandwiched between metal or plastic sheathing. Such a construction provides both efficient and effective control of the temperature and humidity of the environment in the internal space 22 and excellent inclement weather durability for a long, low-maintenance service life. Structures 10 constructed from such modular building panels 40 are also characterized by high strength and will resist high winds and maintain a weather-tight enclosure to protect products held in the space 22 from inclement weather.

In fact, such structures may be easily anchored to the ground such as by means of cooperating nut and bolt anchors 42 where the bolt is received and held in an underlying poured concrete pad 44. Such structures may be specifically designed to withstand winds associated with Category 3, Category 4 or even Category 5 hurricanes as desired. The modular panels 40 also allow the structure 10 to be quickly and easily erected and subsequently removed in a minimal amount of time while producing a minimum of mess.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the door 20 may be provided in the side wall 16 rather than the end wall. Further, more than one set of doors 20 may be provided if desired. The structure could also include a tap connected to the public water supply. Still further, the structure could include a toilet and a shower connected to the public water supply and waste lines. The structure could also be equipped with emergency communications equipment such as a satellite telephone.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of providing a public service, comprising:
placing electronic display devices on storage structures positioned at various product retailers;
storing emergency relief supplies in said storage structures;
displaying advertising over said electronic display devices; and
issuing a public service message over said electronic display devices.

2. The method of claim 1, including placing said storage structures at gas stations.

3. The method of claim 1, including placing said storage structures at convenience stores.

4. The method of claim 1, including placing said storage structures at retail locations along an interstate highway.

5. The method of claim 1 wherein said public service message is an “Amber Alert” emergency message.

6. A method of providing a public service, comprising:
placing electronic display devices on storage structures positioned at various product retailers;
storing emergency drinking water in said storage structures;
displaying advertising over said electronic display devices; and
issuing a public service message over said electronic display devices.

7. The method of claim 6, wherein said public service message is an “Amber Alert” emergency message.

8. The method of claim 6, including placing said storage structures at gas stations.

9. The method of claim 6, including placing said storage structures at retail locations along an interstate highway.

10. The method of claim 6, including placing said storage structures at retail locations along an interstate highway.

11. A method of providing public service, comprising:
placing electronic display devices on storage structures positioned at various product retailers;
storing emergency food in said storage structures;
displaying advertising over said electronic display devices; and
issuing a public service message over said electronic display devices.

12. The method of claim 11, wherein said public service message is an “Amber Alert” emergency message.

13. The method of claim 11, including placing said storage structures at gas stations.

14. The method of claim 11, including placing said storage structures at convenience stores.

15. The method of claim 11, including placing said storage structures at retail locations along an interstate highway.
